(19) United States
(12) Patent Application Publication
(10) Pub. No.: US 2017/0347402 A1
(43) Pub. Date: Nov. 30, 2017

(54) HEATING HANDLE STRUCTURE AND THE METHOD OF MANUFACTURING THE SAME

(71) Applicant: Tong Yah Electronic Technology Co., Ltd., Tainan City (TW)

(72) Inventor: Po-Hsuan WANG, Kaohsiung City (TW)

(21) Appl. No.: 15/605,634

(22) Filed: May 25, 2017

(30) Foreign Application Priority Data
May 27, 2016 (TW) 105207935

(51) Int. Cl. H05B 3/58; B62J 33/00; B62K 21/26; H05B 3/06

(52) U.S. Cl. CPC H05B 3/58; H05B 3/06; B62J 33/00; B62K 21/26

(57) ABSTRACT

The present disclosure provides a heating handle structure and method of manufacturing the same. The heating handle structure includes an inner tube, a metal wire, an electric conductive substrate, a light-permeable seat, a circuit substrate and an outer sleeve. The metal wire surrounds the inner tube, and is connected to the electric conductive substrate. The electric conductive substrate is positioned on the inner tube. The light-permeable seat is disposed at the inner tube. The circuit substrate is disposed on the light-permeable seat. The circuit substrate and the electric conductive substrate are electrically connected. The outer sleeve covers the inner tube. Accordingly, the handle is able to generate heat when the metal wire received electricity, and is able to be maintained at constant temperature by the control of the circuit substrate. The light from the circuit substrate can pass through the light-permeable seat to provide visual effect to users.

### CROSS-REFERENCE TO RELATED APPLICATIONS

This non-provisional application claims priority under 35 U.S.C. §119(a) on Patent Application No(s). 105207935 filed in Taiwan on May 27, 2016, the entire contents of which are hereby incorporated by reference.

### TECHNICAL FIELD

The disclosure is related to a heating handle structure and a method of manufacturing the same, more particular to a heating handle structure having an inner tube capable of being maintained at constant temperature, generating visual effect, and transmitting signals and a method of manufacturing the same.

### BACKGROUND

Generally, handles of vehicles are usually covered by an outer layer, which is made of soft material, such as plastic or rubber, so as to provide users a comfortable feeling and a non-slip effect and absorb vibration. While driving motorcycles or snowmobiles in low temperature environments, users may feel difficult to move their hands to operate the handles because they get cold; in addition, the operation becomes harder because the outer layer covering the handle becomes hard and brittle at low temperature and loses elasticity. Therefore, some manufactures additionally place an inner tube charged with electricity into the handles in order to generate heat.

Please refer a patent with published number of M504762, called “Improved structure of a heating handle for motorcycle”, which is an issued utility patent owned by the Applicant. It includes an inner sleeve, heating wires and an outer sleeve; wherein the inner sleeve is in a tubular shape having hollow portions thereon, the heating wires surround the inner sleeve, and the inner sleeve is sleeved into the outer sleeve.

The aforementioned heating structure can generate heat, but it cannot control the temperature and will cause burn injuries and reduce the lifespan of the outer sleeve.

Furthermore, please refer to another patent with published number of M506084, called “Heat preservation for motorcycle handle”, it includes an electrothermal sheet, a power wire and a sensor. The electrothermal sheet is disposed inside a handle. One end of the power wire is connected to the electrothermal sheet, and the other end of the power wire has a connector for receiving and transferring electricity to the electrothermal sheet via the power wire in order to generate heat. The sensor is disposed between the electrothermal sheet and the power wire, and is able to sense the temperature of the handle so as to open the electrothermal sheet or stop providing electricity to the electrothermal sheet.

When the sensor senses that the handle reaches a specific temperature, it can turn on/off the electrothermal sheet. However, continuously turning on/off the electrothermal sheet will damage the sensor and reduce the lifespan.

Accordingly, the Applicant provide a heating handle structure and a method of manufacturing the same basing on years of experience of developing and manufacturing in order to solve the current problems and provide more practical value to users.

### SUMMARY

The disclosure provides a heating handle structure and a method of manufacturing the same, more particular to a heating handle structure having an inner tube capable of being maintained at constant temperature, generating visual effect, and transmitting signals and a method of manufacturing the same.

The main purpose and effects of the heating handle structure are achieved by embodiments in below:

A heating handle structure includes an inner tube, a metal wire, an electric conductive substrate, a light-permeable seat, a circuit substrate and an outer sleeve. The metal wire surrounds the inner tube, and is connected to the electric conductive substrate. The electric conductive substrate is positioned on the inner tube. The light-permeable seat is disposed at one end of the inner tube. The circuit substrate is disposed on the light-permeable seat. The circuit substrate and the electric conductive substrate are electrically connected to each other. The outer sleeve covers the inner tube. Accordingly, the handle is able to generate heat when the metal wire received electricity, and is able to be maintained at constant temperature by the control of the circuit substrate. The light from the circuit substrate can pass through the light-permeable seat to provide visual effect to users.

According to the aforementioned heating handle structure, the inner tube has a groove for the metal wire to dispose and a longitudinal groove connected to the groove; wherein the longitudinal groove is for positioning the electric conductive substrate.

According to the aforementioned heating handle structure, wherein one end of the electric conductive substrate has an electrode portion electrically connected to the metal wire, and the other end of the electric conductive substrate has an outgoing line portion for signal transmission.

According to the aforementioned heating handle structure, further includes a fixing member, the inner tube has a positioning portion, the fixing member covers the positioning portion, and the fixing member is configured to fix the metal wire to the inner tube.

According to the aforementioned heating handle structure, wherein the circuit substrate further includes a controlling chip, at least one LED unit or electronic signal component, the controlling chip is configured to control the temperature of the metal wire (constant temperature), the LED unit (e.g. brightness, color, lasting time), and the electronic signal component to generate specific electronic signals.

According to the aforementioned heating handle structure, wherein the outer sleeve is formed over the inner tube via an injection molding process, and has a high sealability.

A method of manufacturing a heating handle structure includes the following steps: fixing a metal wire to an electric conductive substrate; placing the electric conductive substrate to a longitudinal groove of an inner tube; disposing the metal wire in a groove surrounding a surface of the inner tube; disposing a light-permeable seat to an end of the inner tube; disposing a circuit substrate into an accommodating space of the light-permeable seat; wherein the circuit substrate and the electric conductive substrate are electrically connected to each other, and at least one electronic component on the circuit substrate is covered by the light-permeable seat so as to be sealed in the accommodating space; and forming an outer sleeve to cover the metal wire, the electric conductive substrate, the light-permeable seat and the circuit substrate via an injection molding process.

As described in above, the present disclosure has the following advantages in comparison with prior art:

1. The circuit substrate is able to control the temperature of the metal wire and keep the handle at a constant temperature for the user to grip.

2. Through the window area, the user is able to see instant status of the vehicle, such as heating status, temperature, voltage warning and relevant settings, so as to ride safely.

3. The user feels more enjoyable while seeing light effects via the window area of the light-permeable seat.

4. The light effects on the handle can be a warning light at night so as to improve safety.

5. The aforementioned effects can be achieved by the controlling chip, and the controlling chip may generate other electronic signals when incorporated with other electronic components or programs.

6. In the method of manufacturing the heating handle structure of the present disclosure, the electronic components, such as the controlling chip and the LED unit, on the circuit substrate are covered by the light-permeable seat so as to be sealed in the accommodating space, so that these electronic components are able to be isolated from the thermoplastic material and not damaged by the high temperature of the thermoplastic material while forming the outer sleeve.

### BRIEF DESCRIPTION OF THE DRAWINGS

The present disclosure will become better understood from the detailed description given hereinbelow and the accompanying drawings which are given by way of illustration only and thus are not intending to limit the present disclosure and wherein:

FIG. 1 is an exploded view of a heating handle structure according to one embodiment of the present disclosure;

FIG. 2 is a partial view of the heating handle structure according to one embodiment of the present disclosure;

FIG. 3 is a perspective view of the heating handle structure according to one embodiment of the present disclosure;

FIG. 4 is a flowchart illustrating a method of manufacturing a heating handle structure according to one embodiment of the present disclosure; and

FIG. 5 is a flowchart illustrating a process of assembling metal wire according to one embodiment of the present disclosure.

### DETAILED DESCRIPTION

The details and advantages of the present disclosure are described in the following embodiments; the person skilled in the art can comprehend and implement the present disclosure in accordance with the specification, claims and drawings of the present disclosure. The following embodiments are detail descriptions of the present disclosure but not intend to limit the present disclosure.

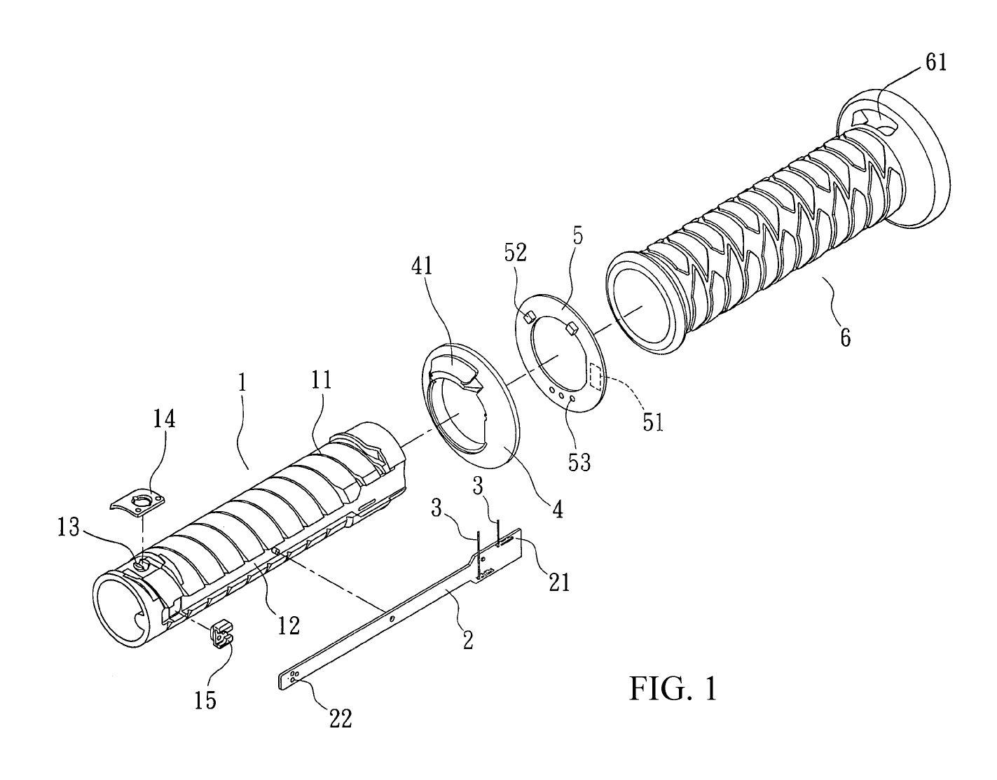

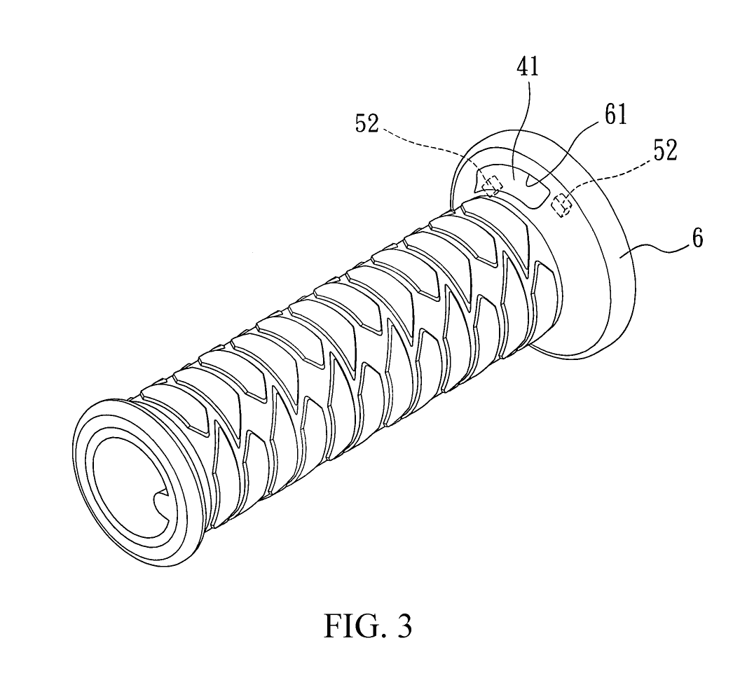

To clearly disclose the content, purpose and effects of the present disclosure, please see the following descriptions and further refer to the respective drawings. Firstly, please refer to FIGS. 1-3, including an exploded view and a perspective view of a heating handle structure of the present disclosure. The heating handle structure includes: an inner tube (1) having a groove (11) surrounding the surface thereof and a longitudinal groove (12) connected to the groove (11); an electric conductive substrate (2) being embedded into the longitudinal groove (12); a metal wire (3) being placed in the groove (11) with two opposite ends electrically connected to the electric conductive substrate (2); a light-permeable seat (4) being assembled to an end of the inner tube (1) with a window area (41); a circuit substrate (5) being disposed inside the light-permeable seat (4) and electrically connected to the electric conductive substrate (2), with a controlling chip (51) for controlling the temperature of the metal wire (3) and a LED unit (52) corresponding to the window area (41); and an outer sleeve (6) covering the inner tube (1), with a hole (61) corresponding to the window area (41) of the light-permeable seat (4) for exposing the window area (41).

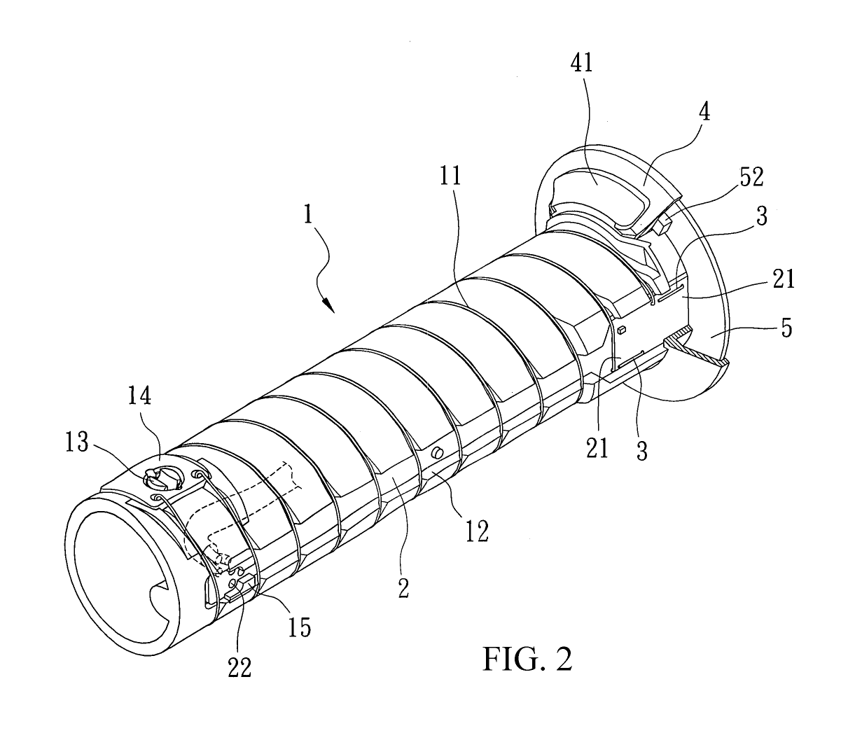

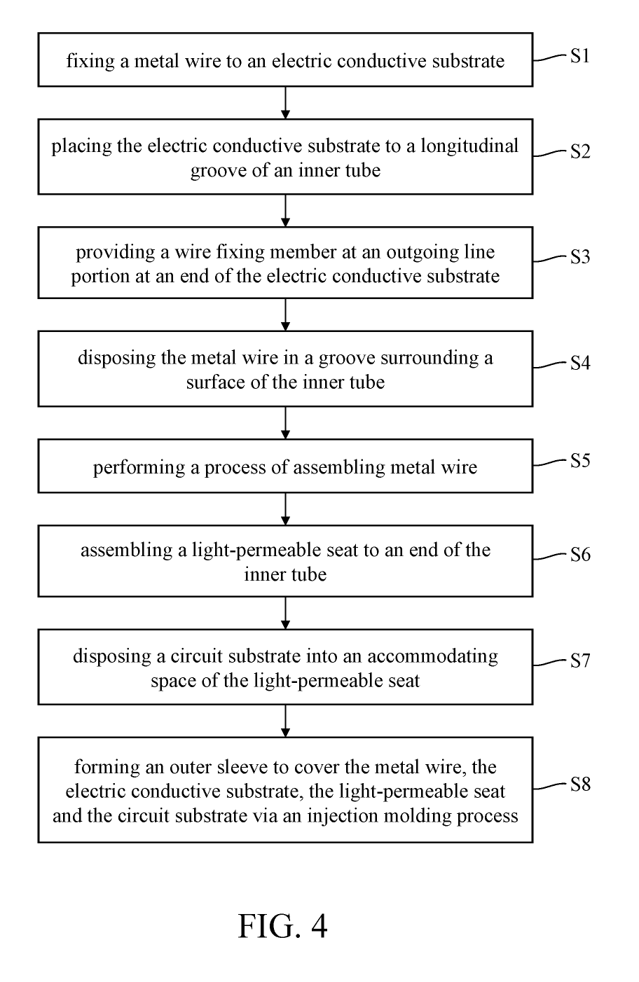

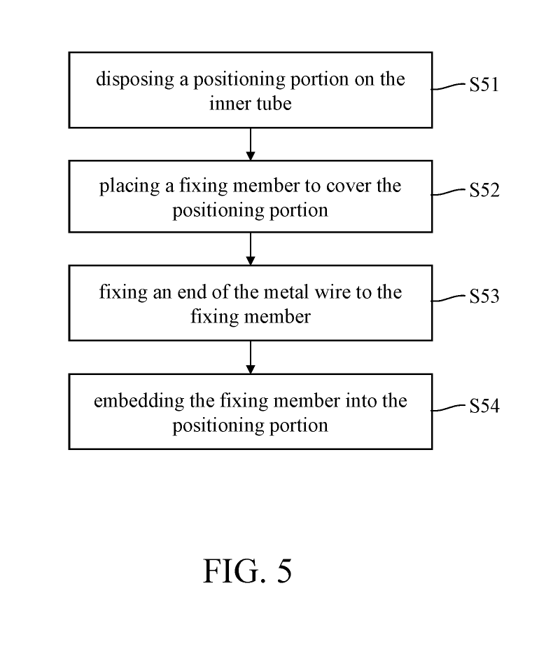

The steps of manufacturing the heating handle structure are described in the following paragraphs. Please refer to FIGS. 1-3 and further refer to FIG. 4. In step S1, the metal wire (3) is fixed to an electrode portion (21) of the electric conductive substrate [as disclosed in another patent application]. In step S2, the electric conductive substrate (2) is placed in the longitudinal groove (12) of the inner tube (1). In step S3, a wire fixing member (15) is provided at an outgoing line portion (22) at an end of the electric conductive substrate (2) in order to protect and fix a wire at the outgoing line portion. In step S4, the metal wire (3) is disposed in the groove (11) surrounding the surface of the inner tube (1). In step S5, a process of assembling metal wire is performed when the metal wire (3) is placed to an end of the groove (11), as the steps S51-S54 shown in FIG. 5. There is a positioning portion (13) disposed on the inner tube (1), and then a fixing member (14) covers the positioning portion (13). Then, the end of the metal wire (3) is fixed to the fixing member (14), and then the fixing member (14) is embedded into the positioning portion (13) of the inner tube (1) in order to firmly fix the metal wire (3) to the inner tube (1), as shown in FIG. 2.

Then, as shown in step S6, the light-permeable seat (4) is assembled to an end the inner tube (1), and the light-permeable seat (4) is permeable to light. As shown in step S7, the circuit substrate (5) is disposed on the light-permeable seat (4), the position of the LED unit (52) on the circuit substrate (5) matches the window area (41), and then the circuit substrate (5) and the electric conductive substrate (2) are connected to each other, for example, via welding, so the controlling chip (51) is able to control the temperature of the metal wire (3) and the mode of the LED unit (52) (e.g. brightness, color, lasting time). The electronic signal component (53) is disposed on the circuit substrate (5); the controlling chip (51) is able to control the electronic signal component (53) to generate specific electronic signals relating to heating status, temperature, voltage warning and relevant settings. The end of the electric conductive substrate (2) has an outgoing line portion (22) for signal transmission so as to transmit single to the circuit substrate (5) or transmit the signal from the circuit substrate (5) to the metal wire (3). It is noted that, in this embodiment, the light-permeable seat (4) has an accommodating space (42) for accommodating the circuit substrate (5), so that the light-permeable seat (4) is able to cover the electronic components, such as the controlling chip (51) and the LED unit (52), on the circuit substrate (5) and seal these electronic components in the accommodating space (42) with the circuit substrate (5).

Lastly, as shown in step S8, the metal wire (3), the electric conductive substrate (2), the light-permeable seat (4) and the circuit substrate (5) are covered by an outer sleeve (6) which is formed via an injection molding process. The electronic components, such as the controlling chip (51) and the LED unit (52), on the circuit substrate (5) are covered by the light-permeable seat (4) so as to be sealed in the accommodating space (42), so that these electronic components are able to be isolated from the thermoplastic material and not damaged by the high temperature of the thermoplastic material while forming the outer sleeve (6). In addition, the outer sleeve (6) has a high sealability since it is formed via the injection molding process. Furthermore, the outer sleeve (6) has a hole (61) to expose the window area (41). The window area (41) can be a LCD screen according to requirements.

As described in above, the present disclosure has the following advantages in comparison with prior art:

1. The circuit substrate is able to control the temperature of the metal wire and keep the handle at a constant temperature for the user to grip.

2. Through the window area, the user is able to see instant status of the vehicle, such as heating status, temperature, voltage warning and relevant settings, so as to ride safely.

3. The user feels more enjoyable while seeing light effects via the window area of the light-permeable seat.

4. The light effects on the handle can be a warning light at night so as to improve safety.

5. The aforementioned effects can be achieved by the controlling chip, and the controlling chip may generate other electronic signals when incorporated with other electronic components or programs.

6. In the method of manufacturing the heating handle structure of the present disclosure, the electronic components, such as the controlling chip and the LED unit, on the circuit substrate are covered by the light-permeable seat so as to be sealed in the accommodating space, so that these electronic components are able to be isolated from the thermoplastic material and not damaged by the high temperature of the thermoplastic material while forming the outer sleeve.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A heating handle structure, comprising:
an inner tube having a groove surrounding a surface thereof and a longitudinal groove connected to the groove;
an electric conductive substrate being embedded to the longitudinal groove of the inner tube;
a metal wire being placed in the groove of the inner tube, two opposite ends of the metal wire electrically connected to the electric conductive substrate;
a light-permeable seat being assembled to an end of the inner tube, the light-permeable seat having a window area;
a circuit substrate being disposed inside the light-permeable seat and electrically connected to the electric conductive substrate, the circuit substrate comprising a controlling chip and at least one LED unit corresponding to the window area, the controlling chip configured to control the temperature of the metal wire; and
an outer sleeve covering the inner tube, the outer sleeve having a hole corresponding to the window area of the light-permeable seat for exposing the window area.

2. The heating handle structure according to claim 1, wherein the electric conductive substrate has an electrode portion at an end thereof electrically connected to the metal wire, the electric conductive substrate has an outgoing line portion at another end thereof for signal transmission.

3. The heating handle structure according to claim 2, further comprising a wire fixing member disposed on the outgoing line portion for protecting and fixing a wire to the outgoing line portion.

4. The heating handle structure according to claim 2, further comprising a fixing member, the inner tube further comprising a positioning portion, the fixing member covering the positioning portion, and the fixing member configured to fix the metal wire.

5. The heating handle structure according to claim 2, wherein the circuit substrate further comprises at least one electronic signal components electrically connected to the controlling chip.

6. The heating handle structure according to claim 1, wherein the outer sleeve is formed over the inner tube via an injection molding process.

7. The heating handle structure according to claim 5, wherein the outer sleeve is formed over the inner tube via an injection molding process.

8. A method of manufacturing a heating handle structure, the method comprising:
fixing a metal wire to an electric conductive substrate;
placing the electric conductive substrate to a longitudinal groove of an inner tube;
disposing the metal wire in a groove surrounding a surface of the inner tube;
assembling a light-permeable seat to an end of the inner tube;
disposing a circuit substrate into an accommodating space of the light-permeable seat;
wherein the circuit substrate and the electric conductive substrate are electrically connected to each other, and at least one electronic component on the circuit substrate is covered by the light-permeable seat so as to be sealed in the accommodating space; and
forming an outer sleeve to cover the metal wire, the electric conductive substrate, the light-permeable seat and the circuit substrate via an injection molding process.

9. The method according to claim 8, before the step of disposing the metal wire in the groove surrounding the surface of the inner tube, further comprising:
disposing a wire fixing member to an outing line portion at end of the electric conductive substrate.

10. The method according to claim 8, before the step of disposing the light-permeable seat to the end of the inner tube further comprising a process of assembling metal wire, the process comprising:
disposing a positioning portion on the inner tube;
placing a fixing member to cover the positioning portion;
fixing an end of the metal wire to the fixing member; and
embedding the fixing member into the positioning portion.
